(19) United States
(12) Patent Application Publication
(10) Pub. No.: US 2008/0271859 A1
(43) Pub. Date: Nov. 6, 2008

(54) Door Controller and Locking Mechanism

(75) Inventors: George Kourtesis, Revesby (AU); John F. Udy, Revesby (AU)

Correspondence Address: MARSH, FISCHMANN & BREYFOGLE LLP, 8055 East Tufts Avenue, Suite 450, Denver, CO, 80237, US

(73) Assignee: B&D AUSTRALIA PTY LTD, Clontarf (AU)

(21) Appl. No.: 11/571,228

(22) PCT Filed: Jun. 23, 2005
(86) PCT No.: PCT/AU05/00910

§ 371 Date: Mar. 21, 2008

(30) Foreign Application Priority Data
Jun. 25, 2004 (AU) 2004903483

(51) Int. Cl. E06B 9/72

(52) U.S. Cl. 160/310; 160/297; 160/311

(57) ABSTRACT

A door controller (10) including an integrated electric motor, said door controller including an integrated stator (14) provided with at least one coil (16) placed about the circumference of said stator, said stator fixed to allow only a substantially small degree of rotation of said stator, in use said stator and a rotatable ring gear (18) adapted to be in electromagnetic interaction with each other so as to rotatably drive said ring gear, rotation of said ring gear effecting movement of said door. A locking mechanism (30) for use in a door controller (10), said door controller including a rotatable ring gear (18) for effecting movement of a door, said ring gear provided with teeth (36), said locking mechanism including: at least one clutch member (32) adapted to move in a radial direction, the at least one clutch member provided with teeth (34) or at least one locking protrusion; at least one resilient member (38) operatively associated with said at least one clutch member; and, at least one protrusion (42) operatively associated with said at least one clutch member; whereby, rotational movement of said at least one protrusion effects or allows radial movement of said at least one clutch member which thereby disengages or engages said teeth or at least one locking protrusion of said at least one clutch member from or with said teeth of said ring gear.

### TECHNICAL FIELD

The present invention generally relates to a door controller which controls movement of a door, rolling door, sectional door, or like door, and in particular, to a door controller with a reduced number of gears in a reduction gearing arrangement required to drive the door, or preferably, to a door controller that can directly drive opening or closing of the door without any reduction gearing arrangement. In another form, the present invention also relates to a locking mechanism for a door controller, with or without a reduction gearing arrangement, which can prevent movement of the door.

### BACKGROUND ART

Doors, such as rolling overhead doors or sectional doors, are known to be used on openings for garages and other buildings and accessible areas. Referring to rolling overhead doors by way of example, such doors typically include a flexible door curtain (eg. composed of a plurality of connected rigid sections) which can be raised and lowered from a drum arrangement located above a door aperture. Typically, a pair of spaced end drums is rotatably mounted on a fixed axle extending horizontally across the top of the door aperture. The door curtain is secured at its upper end to each of the spaced end drums and a ring gear can be secured to one of the drums to effect rotation of the drum arrangement and hence to roll and unroll the flexible door curtain.

Typically, in prior art door controller systems, there are numerous gears required to reduce the speed and increase the torque of an electric motor used to drive movement of the door. These gears, often termed reduction gears or as a ‘reduction gearing arrangement’, can introduce significant failure modes, increase costs of production, increase complexity of assembly and increase noise associated with a door controller. The limited space available for installation of door controllers means that the controller itself is subject to significant size and design limits, which is generally inconsistent with the need for a reduction gearing arrangement. Additionally, existing door controllers using reduction gearing arrangements to achieve the required slow drum rotation and high torque required to operate a roller door or sectional door are more expensive to manufacture than would be the case if the present necessity of the reduction gearing could be avoided, or if the number, size or complexity of reduction gears could be reduced.

For example, Crimmins (AU-759485) discloses a fire door opener having an AC motor drive system with an inline gear reducer. Although a viable solution in some applications, the requirement for an inline gear reducer increases the complexity, possibility of breakdown and cost of the door opener.

Another type of known door controller relies on worm drives or similar screw type mechanisms, which represent alternative forms of reduction gearing arrangement. These types of door controller can be cumbersome, noisy due to misalignment or wear/tolerance effects, and require components that can lead to higher manufacturing costs.

For example, Griffiths et. al. (AU-A-1782295) discloses a drive system for a motor operated garage door with the electric motor arranged to move the garage door via a rotatable worm drive shaft. An arm assembly is fixed to the garage door and the worm drive is rotated by the electric motor to open or close the door.

Other door controller systems are known, for example, Desrochers (WO-93/16262) discloses a door assembly for opening or closing a door having a motor that drives an axle and tensions cables extending from the lowermost door sections. Operation of the door assembly relies on tensioning of the cables and the motor does not directly drive the axle.

Presently, it is not known to provide a door controller based on operation of an electric motor that can directly drive a door, for example a rolling door or a sectional door, without the need for the additional complexity of a reduction gearing arrangement, worm or threaded screw type mechanism, or the like. It would be advantageous if this problem could be addressed, or if the number or size of gears in the reduction gearing arrangement could be reduced.

Furthermore, there exists a need to provide a drive door controller that includes a relatively simple, robust and effective locking mechanism to prevent the door from being opened when a motor is not driving the door. This can be an advantageous feature in relation to security and safety, for both a direct drive door controller and a drive controller with a reduction or other gearing arrangement.

Prior art systems have attempted to rely on automatic locking of garage doors by using a solenoid locking function, however, these prior art systems have proved unreliable. Electric solenoid arrangements require additional complexity and therefore can increase likelihood of failure. Failure of the solenoid results in the motor driving against a mechanical lock, leading to risks of overloading drive gears and electronics.

There is a need for a direct drive door controller, or a door controller with a reduced number or size of gears in a reduction gearing arrangement, that overcomes or at least ameliorates the problems inherent in the prior art.

There is also a need for a new locking mechanism for a door controller that overcomes or at least ameliorates the problems inherent in the prior art.

The reference to any prior art in this specification is not, and should not be taken as, an acknowledgment or any form of suggestion that such prior art forms part of the common general knowledge.

### SUMMARY OF INVENTION

In a first broad form, the present invention provides a door controller including an integrated electric motor, said door controller including an integrated stator provided with at least one coil placed about the circumference of said stator, said stator fixed to allow only a substantially small degree of rotation of said stator, in use said stator and a rotatable ring gear adapted to be in electromagnetic interaction with each other so as to rotatably drive said ring gear, rotation of said ring gear effecting movement of said door.

According to particular, but non-limiting, embodiments of the present invention, one or more of the following preferable or optional features may be provided:
movement of said door occurs without a reduction gearing arrangement;
said stator includes a plurality of wire coils placed about the circumference of said stator and said ring gear includes a plurality of magnets placed about said ring gear;
said stator is held adjacent a housing which allows only a relatively small degree of rotation of said stator;
said ring gear is directly attached to a door drum of a rolling-type door;
said ring gear drives a chain to operate a sectional-type or tilt-type door;
said stator is positioned about an axially protruding hub of said ring gear;
said plurality of magnets are positioned about a flange of said ring gear to circumscribe said plurality of wire coils;
said stator is attached to or integrated with a drive ring;
said drive ring includes at least one axially extending protrusion;
   said door controller includes a locking mechanism which prevents or allows rotation of said ring gear;
said at least one protrusion is adapted to lock or unlock said locking mechanism;
said locking mechanism is unlocked by action of a rotational force generated upon activation of said electric motor;
said locking mechanism can be manually disengaged;
said ring gear is provided with means to drive a gear provided with segment marking means to uniquely represent each of a plurality of segments into which said door is divided;
at least one sensor to sense a unique segment marking and provide an output indicative of a position of said door;
said stator is positioned intermediate to said drive ring and said ring gear; and/or
said stator includes at least one axially extending protrusion.

In a second broad form, the present invention provides a locking mechanism for use in a door controller, said door controller including a rotatable ring gear for effecting movement of a door, said ring gear provided with teeth, said locking mechanism including: at least one clutch member adapted to move in a radial direction, the at least one clutch member provided with teeth or at least one locking protrusion; at least one resilient member operatively associated with said at least one clutch member; and, at least one protrusion operatively associated with said at least one clutch member; whereby, rotational movement of said at least one protrusion effects or allows radial movement of said at least one clutch member which thereby disengages or engages said teeth or at least one locking protrusion of said at least one clutch member from or with said teeth of said ring gear.

According to further particular, but non-limiting, embodiments of the present invention, one or more of the following preferable or optional features may be provided:
said teeth of said ring gear are positioned on a flange which circumscribes said at least one clutch member;
said at least one clutch member is attached to a housing in sliding engagement;
said at least one protrusion rotates due to operation of an electric motor;

said at least one protrusion is attached to a drive ring which is able to rotate through a substantially small angle;
said at least one resilient member is a spring;
said at least one protrusion is associated with an inclined surface of said at least one clutch member;
relatively small arcuate movement of said at least one protrusion forces the at least one clutch member towards a central axis of rotation of said ring gear;
said at least one clutch member is moved radially outward into locking engagement with said ring gear under action of the at least one resilient member;
said at least one clutch member can be withdrawn out of locking engagement with said ring gear by manual rotation of said at least one protrusion;
there is a plurality of angularly spaced said clutch members, said protrusions and said resilient members;
said ring gear is a cap enclosing said locking mechanism;
said locking mechanism is part of a direct drive door controller; and/or said locking mechanism is part of a door controller having a gearing arrangement disposed between said ring gear and said door.

In a particular form, then, the present invention provides a door controller that is relatively simple to manufacture and assemble, whilst still being able to drive the movement of a variety of doors. Advantageously, by reducing or eliminating the number or size of gears normally required in prior art systems, reliability of the door controller can be improved, the design of the door controller can be significantly simplified, and noise and wear problems can be reduced. Furthermore, the size of the door controller can be reduced, facilitating quicker and easier installation, especially in relatively small spaces, such as the limited available side space in many modern garage constructions.

In a further particular form of the present invention, the door controller uses a multi-pole brush-less DC motor to achieve high torque at relatively low speed, preferably without the need for reduction gearing. The use of fewer moving parts carrying mechanical load can advantageously provide relatively quiet and wear-free operation of the door controller.

Where reference is made in this specification and claims to a roller door, it should be appreciated this is intended to signify any similar or analogous type of door, gate or other closure arrangement, including sectional doors, sliding doors, gates, grills, etc.

### BRIEF DESCRIPTION OF THE DRAWINGS

The present invention should become apparent from the following description, which is given by way of example only, of a preferred but non-limiting embodiment thereof, described in connection with the accompanying figures, in which:

FIG. 1 illustrates the main components of a door controller according to a specific embodiment of the present invention;

FIG. 2 illustrates the reverse angle of the door controller illustrated in FIG. 1;

FIG. 3A illustrates an end view of the door controller illustrated in FIGS. 1 and 2;

FIG. 3B illustrates a cross-sectional view along the section A-A shown in FIG. 3A;

FIG. 4A illustrates a possible locking mechanism and clutch members, according to an embodiment of the present invention, when in locked engagement;

FIG. 4B illustrates the locking mechanism of FIG. 4A when the clutch members are being partially withdrawn;

FIG. 4C illustrates the locking mechanism of FIG. 4A when the clutch members are fully withdrawn enabling opening or closing of a door; and

FIGS. 5A and 5B illustrate opposite perspective views of the assembled door controller illustrated in FIG. 1.

### DETAILED DESCRIPTION OF THE DRAWINGS

The following modes are described in order to provide a more precise understanding of the subject matter of the present invention. Throughout the figures, like reference numerals are used to identify similar features, except where expressly otherwise indicated. Reference is made to an overhead rolling door arrangement by way of example; however, it should be appreciated that the invention can equally be applied to other types of doors, for example sectional garage doors. Furthermore, the invention need not be an overhead type door or a garage door.

In a preferred, but non-limiting, embodiment, the door controller should be automatically self-locking and provide the ability for users to move the door manually after having disengaged a drive mechanism of the door. There should also be provided means to manually disengage the locking mechanism to allow the door to be operated manually in the case of a power failure. When an electric motor is not driving the door it should not be possible to manually move the door, so as to prevent, for example, forced entry into a garage by manually back-driving a garage door.

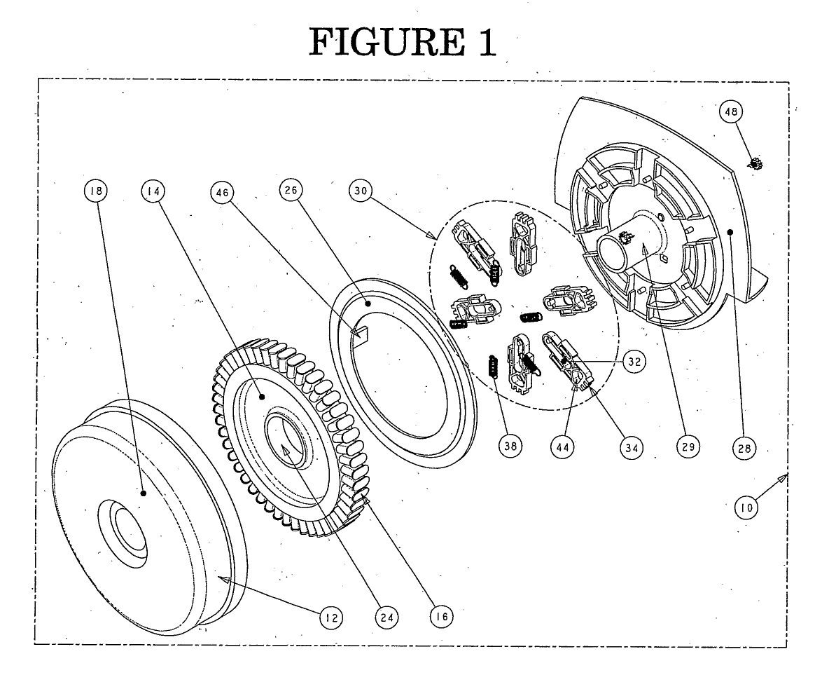

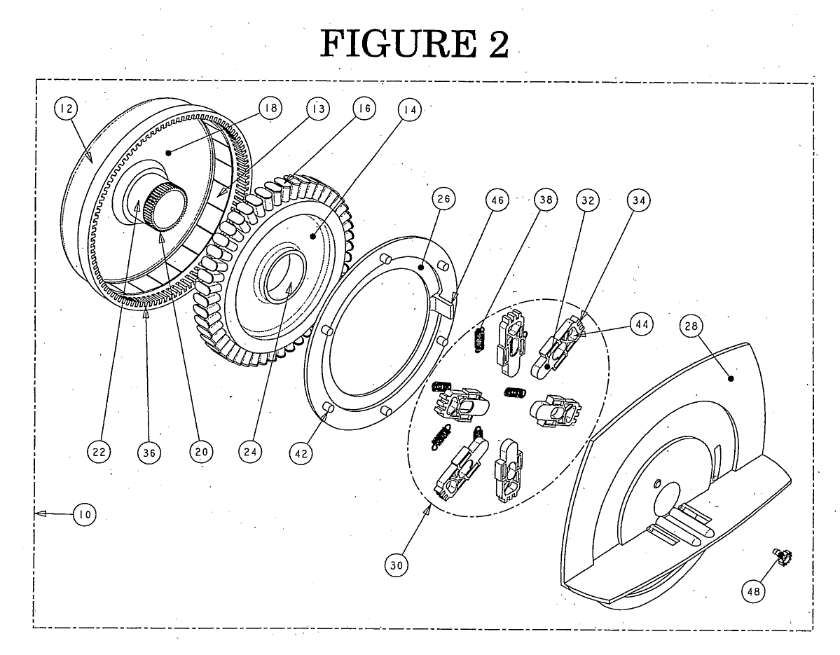

Referring to FIGS. 1 and 2, the door controller 10 includes a substantially fixed stator 14. A series of wire coils 16 are placed or mounted about the circumference of the stator 14 to assist in generating an electromagnetic force to drive rotation of drive gear 18. Positioned on an inside surface of a flange 12, or skirt, are a series of magnets 13. When an electric current passes through wire coils 16 a magnetic field is generated. This current generated magnetic field interacts with the magnetic field from the magnets 13 to force rotation of the ring gear 18. Hence, via electromagnetic interaction, stator 14 and ring gear 18 function as an electric motor to drive rotation of ring gear 18.

It should be noted that it is possible, though not as desirable, that the position of magnets 13 and coils 16 could be interchanged, ie. magnets 13 located on the stator 14 and coils 16 located on the ring gear 18. Also, it should be noted that additional coils arranged to interact with coils 16 could be employed in place of magnets 13.

The stator 14 has a central bore 24 to locate the stator 14 about a hub 22 of the ring gear 18. Hub 22 is positioned about chassis hub 29 which is fixed to chassis 28 (ie. housing). The hub 22 is free to rotate within the central bore 24 and about the chassis hub 29. The stator 14 is held or fixed to the drive ring 26. Either or both the stator 14 and the drive ring 26 are substantially held to the chassis 28 to prevent substantial rotational movement of the stator 14 or the drive ring 26. However, the arrangement allows for small or slight rotational movement of the stator 14 and the drive ring 26.

Thus, the stator 14 is fixed to within a relatively small rotational degree of movement, whilst the ring gear 18 is free to rotate when the action of the electric motor causes such rotation. The coils 16 and magnets 13 can be arranged in any manner that permits effective electromagnetic interaction and resulting forces between the coils 16 and the magnets 13. For example, the coils 16 may be wired in a single electrical series. The stator 14 is mounted within flange 12 of the ring gear 18. Electric current through coils 16 of stator 14 causes rotation of ring gear 18. Various other forms of attachment or association between stator 14 and ring gear 18 can be provided. Alternatively, stator 14 and ring gear 18 may be a single integrated component.

In an optional embodiment, teeth 20 are provided on hub 22 of ring gear 18. Teeth 20 can engage idler gear 48 so that when ring gear 18 rotates idler gear 48 rotates. Idler gear 48 can cause rotation of a further gear that may be marked with segment marking means that can be sensed by a sensor and then processed to determine the absolute position of the door.

In a particular application of the present invention, the ring gear 18 is directly attached or affixed to a door drum of a rolling door. In another particular application of the present invention, the ring gear 18 is fitted with a suitable drive sprocket or toothed wheel to facilitate movement of a sectional or tilt overhead door via a chain, belt or other drive method.

In another particular application of the invention, the ring gear 18 engages and drives a reduction gearing arrangement which in turn drives a door drum of a door or other type of door. Due to the relatively high torque produced by the door controller of the present invention, a reduced number and/or size of gears in a reduction gearing arrangement is required to open or close a door.

When initial action of the electric motor (comprising stator 14 and ring gear 18) causes the initial rotational force acting upon the ring gear 18, there is a corresponding reactive force that acts in the opposite direction on stator 14. As stator 14 is fixed to, or integrated with, drive ring 26, this reactive force results in the drive ring 26 slightly rotating (as the maximum degree of rotation is fixed) relative to the chassis 28.

Rotation of the drive ring 26 acts to disengage the locking mechanism 30 which otherwise prevents rotation of the ring gear 18. The locking mechanism 30, according to one particular embodiment, includes a plurality of clutch members 32, each having a number of teeth 34, or at least one locking protrusion, that engage with teeth 36, or-recesses, provided on an inside surface of flange 12 of the ring gear 18. The clutch members 32 move radially into locking engagement with the teeth 36 of the ring gear 18 under resilient action of springs 38. It should be noted that other types of resilient members could be utilised, for example resilient plastics or a magnetic arrangement. The clutch members 32 are held or positioned adjacent the chassis 28, but are in sliding engagement with the chassis so that clutch members 32 may move in a radial direction but not in a rotational direction.

At rest, that is when the electric motor is not driving ring gear 18, springs 38 act on clutch members 32 to maintain engagement between teeth 34 of clutch members 32 and teeth 36 of ring gear 18, preventing rotation of ring gear 18, and thus preventing movement of the door.

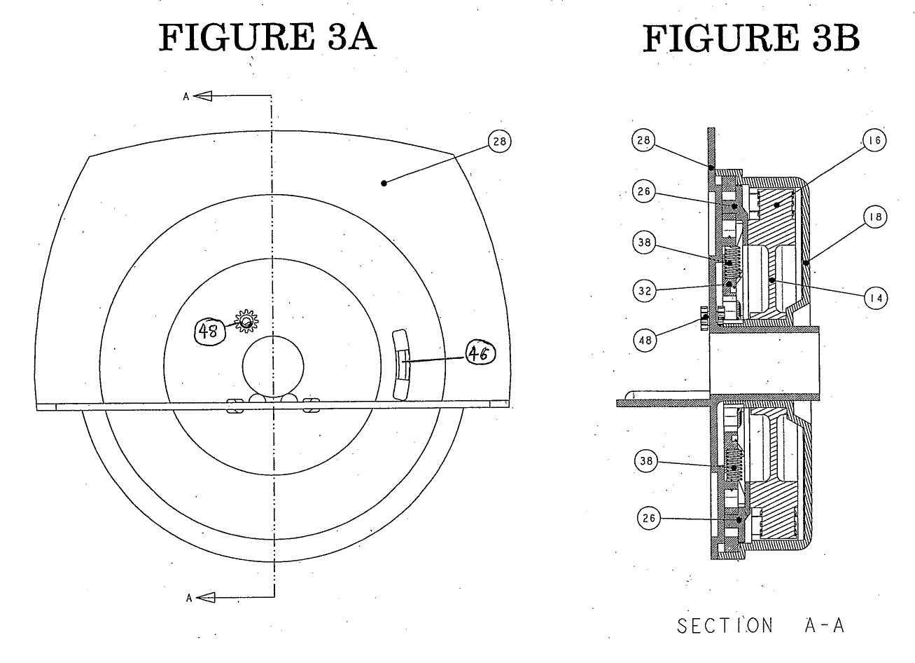

FIGS. 3A and 3B illustrate an end view of the door controller 10 and a cross-sectional view thereof, respectively.

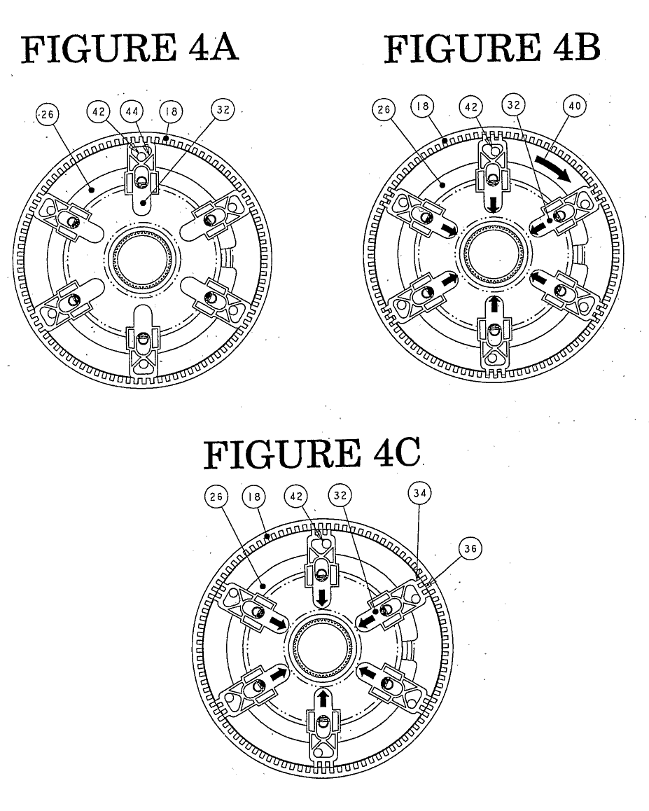

FIGS. 4A, 4B and 4C, show an end view of the association between clutch members 32 and ring gear 18. In FIG. 4A, clutch members 32 are engaged with ring gear 18. Clutch members 32, sit on, are held against or are fixed to chassis 28 and may only move in a radial direction. As clutch members 32 are held in fixed angular positions, ring gear 18 cannot rotate. In FIG. 4B, clutch members 32 are beginning to be pulled towards the centre axis of ring gear 18 by slight rotation 40 of drive ring 26. In FIG. 4C, teeth 34 of clutch members 32 have been fully disengaged from teeth 36 of ring gear 18, thereby allowing free rotation of ring gear 18. When action of the electric motor ceases, ie. current is no longer driven in coils 16, the action of springs 38 is to pull clutch members 32 back into locked engagement with ring gear 18, thereby preventing movement of the door.

The drive ring 26 is only free to rotate within a relatively small range of angle relative to chassis 28, this rotation being at least partially limited by pins 42 on drive ring 26 contacting ramp feature 44, of clutch members 32. If required, other rotational limiting means, such as stubs, protrusions, etc., can be provided on chassis 28. Ramp feature 44 may alternatively be provided as another type of feature, provided on or as part of clutch members 32, for example an angled protrusion or an angled recess.

The initial rotational force generated by the electric motor results in relatively slight rotational movement of drive ring 26 relative to chassis 28. Normally, the rotation of drive ring 26 is in the opposite direction to that of ring gear 18. The pins 42 on drive ring 26 engage with ramp feature 44 on clutch members 32. The rotation of the drive ring 26 relative to the chassis 28, causes the pins 42 to retract the teeth 34 of clutch members 32 from the internal teeth 36 of the ring gear 18. In this manner, the relatively small initial reactive rotation of the stator 14 causes the automatic locking mechanism 30 to become disengaged, thereby allowing free rotation of the ring gear 18, and thus movement of the door. When the electric motor is de-energised and motive force is removed from the drive ring 26, relative to the ring gear 18, the clutch members 32 re-engage ring gear 18 under the contractive force of the springs 38.

The drive ring 26 can be provided as an integral part of the motor windings assembly of stator 14, ie. protrusions 42 could be provided as part of stator 14, without a separately identifiable drive ring 26.

The locking mechanism 30 can be manually disengaged by manually rotating the drive ring 26 using tab 46 provided on drive ring 26 protruding from chassis 28. When tab 46 is maintained at a rotated position relative to chassis 28, the clutch members 32 are disengaged by action of protrusions 42 and the ring gear 18 is free to rotate. Although six clutch members 32 are illustrated, any number of clutch members 32 can be utilised. Tab 46 may be operable remotely from the controller 10, for example by means of pull cord (not shown) readily manipulated by a user at ground level. Additionally, means may be provided to selectively maintain tab 46 in its rotated position relative to chassis 28, so that a user can temporarily set the controller in the disengaged configuration while manually operating the door.

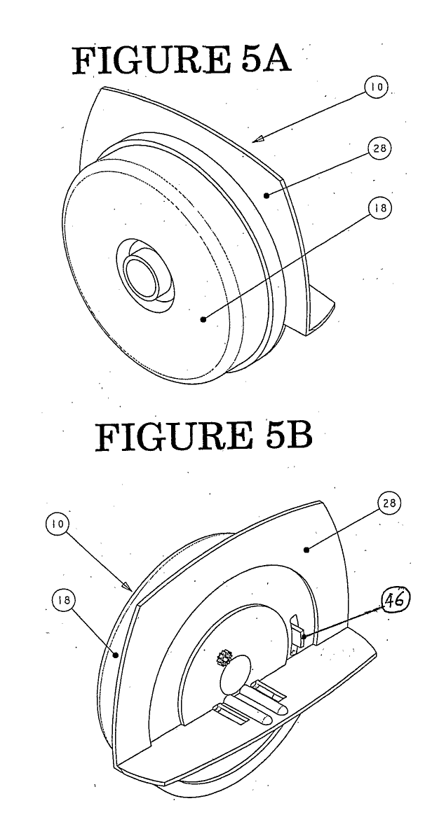

Illustrated in FIGS. 5A and 5B are alternate perspective views of the assembled door controller 10. Ring gear 18 is preferably provided as a cap having a base section and a flange or circular skirt 12, as illustrated, so that ring gear 18 encases stator 14, drive ring 26 and locking mechanism 30 against chassis 28.

Components of the door controller 10 may be selectively manufactured from any suitable materials, for example cast metals or moulded plastics.

In a still further particular form of the present invention, presented by way of example only, the stator 14 uses forty-two wound coils 16 spaced circumferentially on the stator 14. These coils 16 are arranged in a star connected three-phase configuration. It should be noted that alternative numbers of coils and connection configurations are possible, including, but not limited to, delta connection or four phase configurations. The coil windings are formed upon laminated grain oriented steel core material to create the coil elements 16. It should be noted that alternative materials may be utilized, material selection is required to consider factors such as cost, -performance, -motor volume trade-off and commercial availability of such materials. The magnets 13 arranged around the ring gear 18 use a rare-earth ferrite material, however as noted above, alternative materials may be utilized without deviating from the scope and intent of the present invention. Where forty-two coils 16 are connected in a three-phase configuration, fourteen magnets are preferably used to complete the function of the electric motor. It will be apparent to those skilled in the art that a different number and configuration of coils 16 may require a different number of magnets 13 to complete the electric motor.

The door controller 10 can also be provided with segment marking means (not illustrated), as discussed previously in respect of the idler gear 48. For example, segment marking means provided on a gear (not illustrated) driven by idler gear 48, or provided on ring gear 18 itself, can be used to uniquely represent each of a plurality of segments into which the door is divided. Such segment marking means are disclosed in Australian Patent Application No. 2004201640, herein incorporated into the present specification by cross-reference. A sensor can be provided with the door controller 10 to sense the segment marking means and thereby obtain an output indicating the absolute position of the door which can be determined using a processor. Control and supervisory electronics can be provided for electronic operation and safety monitoring of the door controller 10 and door operation. The sensors (not illustrated) may be, for example, hall effect magnetic sensors or optical interrupter sensors.

The invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made by one of ordinary skill in the art without departing from the scope of the present invention.

1. A door controller including an integrated electric motor, said door controller including an integrated stator provided with at least one coil placed about the circumference of said stator, said stator fixed to allow no more than a substantially small degree of rotation of said stator, said stator and a rotatable ring gear adapted to be in electromagnetic interaction with each other in use, so as to rotatably drive said ring gear, rotation of said ring gear effecting movement of said door.

2. The door controller of claim 1, wherein movement of said door occurs without the intermediary of a reduction gearing arrangement.

3. The door controller of claim 1, wherein said stator includes a plurality of wire coils placed about the circumference of said stator and said ring gear includes a plurality of magnets placed about said ring gear.

4. The door controller of claim 1, wherein said stator is disposed relative to a housing, the housing fixedly mountable to provide support for the controller, the controller configured to allow a relatively small degree of rotation of said stator relative to said housing.

5. The door controller of claim 1, wherein said ring gear is directly attached to a door drum of a rolling door.

6. The door controller of claim 1, wherein said ring gear drives a chain to operate a sectional-type or tilt-type door.

7. The door controller of claim 1, wherein said stator is positioned about an axially protruding hub of said ring gear.

8. The door controller of claim 3, wherein said magnets are positioned about a flange of said ring gear to circumscribe said plurality of wire coils.

9. The door controller of claim 1, wherein said stator is fixedly connected to at least one axially extending protrusion.

10. The door controller of claim 1, wherein said door controller includes a locking mechanism operable between a locked position to prevent rotation of said ring gear, and an unlocked position to allow rotation of said ring gear.

11. The door controller of claim 10, wherein said stator is fixedly connected to at least one axially extending protrusion, said at least one protrusion being adapted to cause or permit the operation of said locking mechanism.

12. The door controller of claim 10, wherein said locking mechanism is arranged to be moved into the unlocked position by action of a rotational force generated upon activation of said electric motor.

13. The door controller of claim 10, wherein said locking mechanism is configured to be manually disengageable.

14. The door controller of claim 1, wherein said ring gear is provided with means to drive a gear provided with segment marking means to uniquely represent each of a plurality of segments into which said door is divided.

15. The door controller of claim 14, including at least one sensor configured to sense said segment marking and provide an output indicative of a position of said door.

16. The door controller of claim 9, wherein said stator is attached to or integrated with a drive ring, the drive ring being provided with said at least one axially extending protrusion.

17. The door controller of claim 16, wherein said stator is positioned between said drive ring and said ring gear.

18. A locking mechanism for use in a door controller, said door controller including a rotatable ring gear for effecting movement of a door, said ring gear provided with teeth, the locking mechanism including:
at least one clutch member adapted to move in a radial direction, the at least one clutch member provided with teeth or at least one locking projection;
at least one resilient member operatively associated with said at least one clutch member; and
at least one protrusion operatively associated with said at least one clutch member;
whereby movement of said at least one protrusion causes or permits radial movement of said at least one clutch member thereby to disengage or engage said teeth or at least one locking projection of said at least one clutch member from or with said teeth of said ring gear.

19. The locking mechanism of claim 18, wherein said teeth of said ring gear are positioned on a flange which circumscribes said at least one clutch member.

20. The locking mechanism of claim 18, wherein said at least one clutch member is attached to a housing in sliding engagement therewith.

21. The locking mechanism of claim 18, wherein said at least one protrusion is operable to rotate due to operation of an electric motor of said door controller.

22. The locking mechanism of claim 18, wherein said at least one protrusion is attached to a drive ring which is able to rotate through a substantially small angle relative to a fixed housing of said door controller.

23. The locking mechanism of claim 18, wherein said at least one resilient member is a spring.

24. The locking mechanism of claim 18, wherein said at least one protrusion is associated with an inclined surface of said at least one clutch member.

25. The locking mechanism of claim 18, wherein relatively small arcuate movement of said at least one protrusion forces the at least one clutch member towards a central axis of rotation of said ring gear.

26. The locking mechanism of claim 18, wherein said at least one clutch member is moved radially outward into locking engagement with said ring gear under action of the at least one resilient member.

27. The locking mechanism of claim 18, wherein said at least one clutch member can be selectively withdrawn out of locking engagement with said ring gear by manual rotation of said at least one protrusion.

28. The locking mechanism of claim 18, including a plurality of angularly spaced said clutch members, said protrusions and said resilient members.

29. The locking mechanism of claim 18, wherein said ring gear is part of a cap enclosing said locking mechanism.

30. The locking mechanism of claim 18, wherein said locking mechanism is part of a direct drive door controller.

31. The locking mechanism of claim 18, wherein said locking mechanism is part of a door controller having a gearing arrangement disposed between said ring gear and said door.

32. A door controller including an integrated electric multi-pole brush-less DC motor to provide relatively high torque to a door at relatively low speed, wherein movement of said door occurs without the intermediary of a reduction gearing arrangement.
